(19) United States
(12) Patent Application Publication
(10) Pub. No.: US 2006/0215222 A1
(43) Pub. Date: Sep. 28, 2006

(54) Printing device and print control program

(75) Inventor: Atsuhiko Kurachi, Komaki-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, NAGOYA-SHI (JP)

(21) Appl. No.: 11/386,774

(22) Filed: Mar. 23, 2006

(30) Foreign Application Priority Data
Mar. 24, 2005 (JP) 2005-086057

(51) Int. Cl. G06K 15/00

(52) U.S. Cl. 358/1.16

(57) ABSTRACT

A printing device executes printing every time when a print execution instruction is issued. The printing device include a data receiving unit configured to receive print data from an external device, a print target data storing unit configured to store print target data to be referred to when the printing operation is executed from among the data received by the data receiving unit, a switching judgment unit configured to judge whether the print target data currently stored in the print target data storage unit should be overwritten with newly received print data, a switching unit configured to switch the print target data stored in the print target data storing unit to the received data when the switching judgment unit determines that the print target data is to be switched, and a holding unit configured to hold the received data until the print target data is determined to be switched.

### CROSS-REFERENCE TO RELATED APPLICATION

This application claims priority from Japanese Patent Application No. 2005-086057, filed on Mar. 24, 2005, the entire subject matter of the application is incorporated herein by reference.

### BACKGROUND

1. Technical Field

Aspects of the invention relate to a printing device that receives print data from an external device and executes a printing operation in accordance with a print execution instruction, and a print control program that controls such a printing operation.

2. Description of Related Art

Generally, a printing device that ejects ink drops to a recording medium is configured such that ink is introduced from an ink reservoir to a plurality of ejection channels of an inkjet head. By selectively driving actuators such as heat generating elements or piezoelectric elements, ink drops are ejected selectively from ejection nozzles provided at the tips of the ejection channels. In such a printing device, typically, paper is used as the recording medium. Recently, however, there is a requirement that the printing is executed on fabric such as a T-shirt.

When the printing is executed on paper, the printing operation proceeds as follows. That is, when the user input a print instruction through an external device such as a personal computer connected to the printing device, the printing operation is automatically executed without requiring a user's operation of the printing device. When the printing on fabric is executed, the recording medium (i.e., fabric) must be firmly fixed to a retainer such as platen. After the user confirms that the printing operation can be executed, the printing operation should be started. That is, even though the print instruction is received from the external device, the printing operation will be not be started automatically. Such a printing device for printing on the fabric is typically provided with an operation member such as a print start button, and the user should check some conditions: a remaining amount of the ink; completion of print data reception; installation of waste ink tank; fixing of the recording medium and the like before the user operates the operation member to start printing.

Incidentally, the printers are generally configured such that the print data received from the external device is retained, and based on the retained print data, the printing operation may be executed repeatedly even though an initially instructed images have been printed. In such a printing device having a storage for the print data, when another piece of print data is received, it is typical that the new piece of print data overwrites the old data in the storage. In such a configuration, however, if the user intends to use the previous data for printing, or if the intended number of printings have not been formed before the new data is received, the user cannot use the previous data for printing. Japanese Patent Provisional Publication No. HEI 11-138918 (hereinafter, referred to as '918 publication) discloses a solution to such a problem. An imaging apparatus disclosed in '918 publication is configured such that if the user instructs to hold the image data (print data), it is retained even after the printing operation is finished and another piece of data is transmitted. Only when the holding status is released, the new data overwrites the old data.

In the printer configured to start the printing operation in response to an operation of an operable member such as a print start button, whether the printing of the designated number of printings of recording medium is executed depends on the user's operation of the operable member. Thus, whether the new data overwrites the old data may be dependent on the user's operation.

### SUMMARY OF THE INVENTION

Aspects of the invention are advantageous in that there is provided an improved printing device with which the print data can be switched with requiring less burden to the user.

### BRIEF DESCRIPTION OF THE ACCOMPANYING DRAWINGS

FIG. 1 is a perspective view showing a structure of an inkjet printer according to aspects of the invention.

FIG. 2 is a front view of an operation panel of the inkjet printer according to aspects of the first embodiment.

FIG. 3 is a block diagram showing an electric configuration of the inkjet printer according to aspects of the invention.

FIG. 4 is a flowchart illustrating a data receiving procedure according to aspects of a first embodiment of the invention.

FIG. 5 is an example of a displayed image on an LCD according to aspects of the invention.

FIG. 6 is an example of a displayed image on an LCD according to aspects of the invention.

FIG. 7 is a flowchart illustrating a printing procedure according to aspects of the first embodiment of the invention.

FIG. 8 is an example of a displayed image on an LCD according to aspects of the invention.

FIG. 9 is a flowchart illustrating a pausing procedure according to aspects of the first embodiment of the invention.

FIG. 10 is an example of a displayed image on an LCD according to aspects of the invention.

FIG. 11 is an example of a displayed image on an LCD according to aspects of the invention.

FIG. 12 is a flowchart illustrating a data receiving procedure according to aspects of a modification of the first embodiment.

FIG. 13 is a flowchart illustrating a mode changing procedure according to aspects of the invention.

FIG. 14 is a flowchart illustrating a data receiving procedure according to aspects of the invention when a print data retain mode is ON and a print-number dependent mode is ON.

FIG. 15 is a flowchart illustrating a printing procedure according to aspects of the invention when the print data retain mode is ON and the number of printings dependent mode is ON.

FIG. 16 is a flowchart illustrating a data receiving procedure according to aspects of the invention when the print data retain mode is ON and the number of printings dependent mode is OFF.

FIG. 17 is a flowchart illustrating a printing procedure according to aspects of the invention when the print data retain mode is ON and the number of printings dependent mode is OFF.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to aspects of the invention, there is provided a printing device that executes a printing operation based on print data every time when a print execution instruction is issued. The printing device include a data receiving unit configured to receive print data from an external device, a print target data storing unit configured to store print target data to be referred to when the printing operation is executed from among the data received by the data receiving unit, a switching judgment unit configured to judge whether the print target data currently stored in the print target data storage unit should be overwritten with newly received print data, a switching unit configured to switch the print target data stored in the print target data storing unit to the received data when the switching judgment unit determines that the print target data is to be switched, and a holding unit configured to hold the received data until the switching judgment unit determines that the print target data should be switched.

The printing device may further include a print number counting unit configured to count the number of printings having been formed based on the print target data stored in the print target data storage unit, and a designated number completion judging unit configured to judge whether the number of printings counted by the print number counting unit has reached a preliminarily designated number of printings. The switching judgment unit may determine that the print target data is to be switched when the designated number completion judging unit determines that the number of printings counted by the print number counting unit has reached the preliminarily designated number of printings.

The printing device may further include a reception notifying unit configured to notify that the reception unit receives the print data, and a holding notifying unit configured to notify that there exists held data which is the received data held by the holding unit.

The printing device may include a print number counting unit configured to count the number of printings having been formed based on the print target data stored in the print target data storage unit, a designated number completion judging unit configured to judge whether the number of printings counted by the print number counting unit has reached a preliminarily designated number of printings, and a switching permission input unit allowing a user to input an instruction indicating whether the print target data stored in the print target data storage unit is to be replaced with one of the received data and the held data. The reception notifying unit may notify that the print data is received when the receiving unit receives the print data and the designated number completion judging unit determines that the number of printings has reached the designated number. The holding unit holds the received data when the receiving unit receives the print data and the designated number completion judging unit determines that the number of printings has not reached the designated number. The switching permission input unit may input whether the print target data is to be switched to the received data when the reception notifying unit notifies that the print data is received. Further, the switching judgment unit may judge whether the print target data is switched based on the input through the input unit.

The printing device may further include a counting unit configured to count the number of printings having been formed based on the print target data stored in the print target data storage unit, a designated number completion judging unit configured to judge whether the number of printings counted by the print number counting unit has reached a preliminarily designated number of printings and a switching permission input unit allowing a user to input an instruction indicating whether the print target data stored in the print target data storage unit is to be replaced with one of the received data and the held data. The reception notifying unit notifies that the print data is received when the receiving unit receives the print data and the designated number completion judging unit determines that the number of printings has reached the designated number. The holding unit holds the received data when the receiving unit receives the print data and the designated number completion judging unit determines that the number of printings has not reached the designated number, the switching permission input unit may input whether the print target data is to be switched to the held data when the holding notifying unit notifies that there exists held data. The switching judgment unit may judge whether the print target data is switched based on the input through the input unit.

The printing device may further includes a mode setting unit that sets operation modes of the inkjet device to one of a switching mode in which the print target data is switched to the received data, and a non-switching mode in which the print target data is not switched. The switching judgment unit may judge whether the print target data is switched based on the mode set by the mode setting unit.

The printing device may further include a mode input unit that allows the user to input the mode. The mode setting unit executes setting of the mode based on the input through the mode input unit.

The printing device may include a print number counting unit configured to count the number of printings in accordance with the print target data, and a designated number completion judging unit configured to judge whether the number of printings counted by the print number counting unit has reached a preliminarily designated number of printings. The non-switching mode may include at least one of an input standby mode in which the switching of the print target data is not done when the receiving unit receives the print data and the print target data is switched based on the input by the user thereafter; and a print number dependent mode in which switching of the print target data is not done when the receiving unit receives the print data and the print target data is switched after the designated number completion judging unit judges that the designated number of printings have been formed.

According to aspects of the invention, there is provided a computer program product comprising a computer readable instructions that cause a computer to execute a printing operation based on print data every time when a print execution instruction is issued. The instructions cause the computer to execute as the printing device described above.

### EMBODIMENTS

Referring to the accompanying drawings, aspects of the invention will be described in detail. In the illustrative embodiment described below, the printing device according to aspects of the invention is applied to a well-known inkjet printer 1 for printing images on fabric.

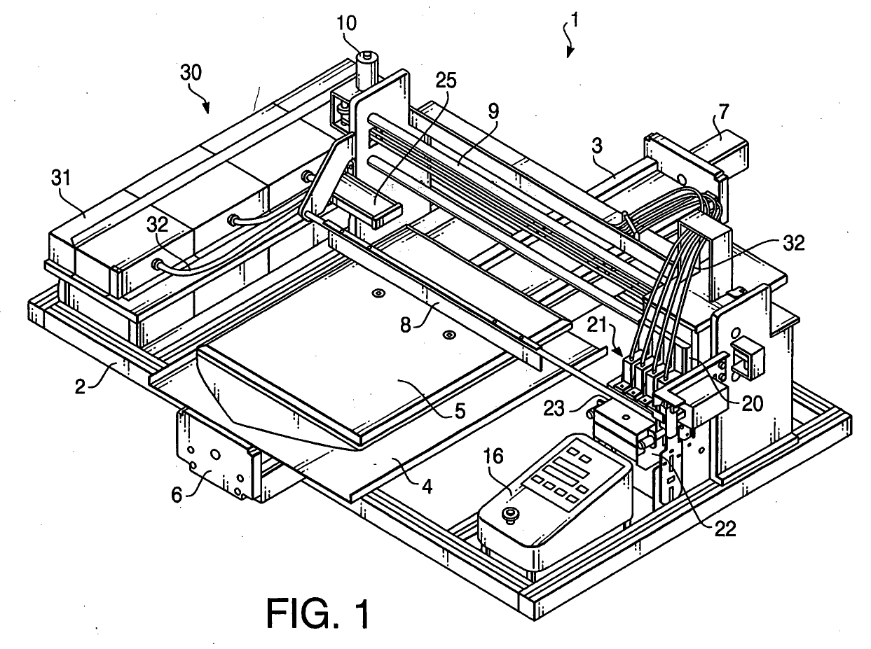

First, the inkjet printer 1 configured to print images on the fabric such as a T-shirt will be described. FIG. 1 is a perspective view of an overall structure of the inkjet printer 1 according to aspects of the invention.

As shown in FIG. 1, the inkjet printer 1 has a casing 2 which has a shape of right angled parallelepiped whose longer sides extend in right-and-left direction. On the bottom surface of the casing 2, a pair of rails 3 extending in the front-and-rear direction. The pair of rails 3 are supported on base portions perpendicularly rising from the casing 2, respectively. The pair of rails 3 support a platen supporting plate (not shown) which is movable, along the pair of rails 3, in the front-and-rear direction of the casing 2. Substantially at the center of the platen supporting plate, a supporting rod stands perpendicularly, and at the upper end of the supporting rod, an exchangeable platen 5 is secured.

The platen 5 is a rectangular plated, when viewed from the top, having longer sides which extend in the front-and-rear direction of the casing 2. On the platen 5, the recording medium (fabric) such as a T-shirt is placed horizontally. At an intermediate position between the platen 5 and the supporting plate, a tray 4 is secured to the supporting rod. The tray receives the sleeves of the T-shirt or the like when held on the platen 5 so that the sleeves or the like do not fall on the bottom surface of the casing 2. At a rear portion of a platen driving mechanism 6 having the pair of rails 3 to move the platen supporting plate, a platen driving motor 7 is provided. By driving the platen driving motor 7, the platen supporting plate moves along the pair of rails 3, in the front-and-rear direction of the casing 2.

At a central position in the front-and-rear direction of the casing 2, and above the platen 5, a pair of guide rails 9 extend between two side walls of the casing 2. The guide rails 9 guide movement of a carriage 20 mounting inkjet head 21. When a carriage motor 10 provided at a left-hand side end portion of the guide rails 9 in FIG. 1 is driven, the carriage 20 moves in the right-and-left direction of the casing along the pair of guide rails 9.

According to the illustrative embodiment, the inkjet printer 1 uses cyan ink, magenta ink, yellow ink, and black ink. On the left side surface of the inkjet printer 1, four ink cartridge chambers 30 are arranged to detachably accommodate the ink cartridge for the four colors, respectively. To each ink cartridge chamber 30, a flexible ink supply tube 32 is connected, and the ink is drawn from each ink cartridge 31 to each inkjet head 21 via the ink supply tube 32.

The carriage 20 mounts thereon four inkjet heads 21. Each inkjet head 21 is formed with a plurality of (e.g., 128) ink ejection channels (not shown) for ejecting ink. Each of the ink ejection channels is provided with a piezoelectric actuator (not shown), and by driving the piezoelectric actuator, ink is ejected downward from minute nozzles (not shown) formed on the bottom surface of the inkjet head corresponding to ink ejection channels, respectively.

At a right side end position of the movable range of the carriage 20 along the guide rails 9, a purge unit 22 having suction caps 23 which can be closely and detachably attached to the nozzle surfaces of the inkjet heads 21. The purge unit 22 is provided with a suction pump (not shown). When the suction caps 23 are closed attached to the inkjet heads 21, ink can be sucked via the suction caps 23. Further, when printing is not executed, the suction caps 23 cover the nozzle surfaces of the inkjet heads 21, and ink is prevented from drying.

Similar to the purge unit 22, at the right end position of the movable range of the carriage 20 along the guide rails 9, a wipe mechanism (not shown) is provided to wipe the ink adhered on the nozzle surfaces of the inkjet heads 21.

At the left end position of the movable range of the carriage 20 along the guide rails 9, an ink receiver 25 for receiving the ink which is ejected not for imaging but for avoiding increase of viscosity due to drying.

At a slightly forward (i.e., front side) position with respect to the guide rails 9, a clearance sensor 8 is provided to extend in a right-and-left direction. The clearance sensor 8 is for detecting wrinkles and obstacles such as dusts on the recording medium (fabric) placed on the platen 5 when the platen 5 is moved, along the rails 3, from the front side to the rear side and an image is formed on the recording medium (fabric). At the right front side of the casing, an operation panel 16 for operating the inkjet printer 1 is provided. The operation panel 16 has an LCD (Liquid Crystal Display), a print button, a cancel button and the like.

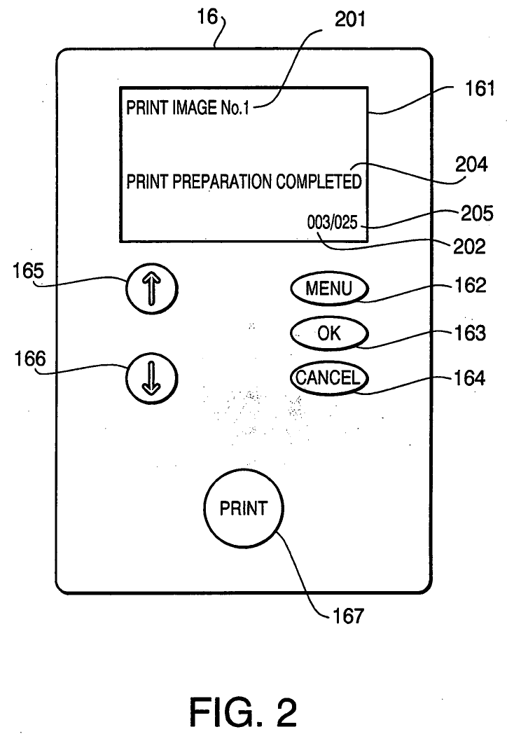

FIG. 2 is an enlarged front view of the operation panel 16. As shown in FIG. 2, on the operation panel 16, an LCD (Liquid Crystal Display) 161 for displaying a menu and various operational states of the inkjet printer 1, a menu button 162 for displaying a menu on the LCD 161, an OK button 163 and a cancel button 164 used for allowing/rejecting the reception of the print data and mode setting, a move-up button 165 and move-down button 166 for selecting menu times, a print start button 167 for instructing start of printing, and the like.

On the LCD 161, a name 201 of the data currently subjected to be printed, a current status 204 of the inkjet printer 1, the number 203 of printings instructed to be printed, and the number 202 of printings having been printed. Further, depending on the status, an inquiring message for the user or the like may be displayed. FIG. 2 shows a case where the name of the data is “Print image No. 1”, the number of printings to be printed is 25, 3 printings have been formed, and the print preparation has been completed. At this stage, if the user depresses the print start button 167, the next printing job (i.e., fourth printing) will be executed.

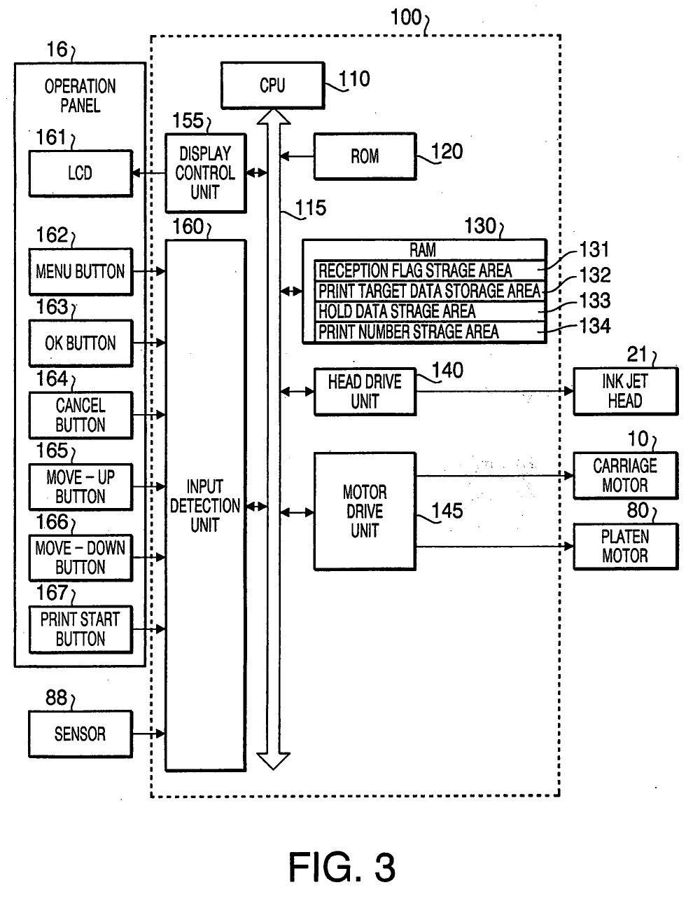

Next, an electrical configuration of the inkjet printer 1 will be described. FIG. 3 is a block diagram showing the electrical configuration of the inkjet printer 1. As shown in FIG. 3, the control unit 100 of the inkjet printer 1 includes a CPU 110 that controls the entire operation of the inkjet printer 1. The CPU 110 is connected, via a bus 115, with a ROM 120 storing various control programs to be executed by the CPU 110, and a RAM 130 that temporarily stores data. The RAM 130 includes a reception flag storage area 131 that stores a reception flag which is set to ON when the print data is received, a print target data storage area 132 that stores the print target data, a holding data storage area 133 which holds the print data as received, and the print number storage area 134. Further, the CPU 110 is connected with a head driving unit 140 for driving the piezoelectric actuators provided to respective channels of the inkjet heads 21, a motor driving unit 145 for driving the carriage motor 10 and the platen motor 80 via the bus 115.

The CPU 110 is further connected with a display control unit 155 for displaying the menu, data reception status, holding status and the like on the LCD 161, and an input detection unit 160 via the bus 115. The input detection unit 160 is connected with various sensors 88 to detect whether the inkjet printer 1 can execute printing, the menu button 162, the OK button 163, the cancel button 164, the move-up button 165, the move-down button 166, the print start button 167 and various other buttons provided on the operation panel 16.

Next, the operation of the inkjet printer 1 configured as above will be described.

When the inkjet printer 1 is powered ON, the control program stored in the ROM 120 is retrieved and initializing processes are executed. When the print data is received from an external device, the print data is stored in the target print data storage area 132. The user then places the recording medium (e.g., T-shirt) on the platen 5, confirms that various printing conditions are satisfied, and depresses the print start button 167. Then, the printing operation is started. That is, the platen motor 80 is driven and the platen 5 is once moved to an initial position which is defined as the rear side position. Then, the platen 5 is moved to its end position. Synchronously with the movement of the platen, the carriage 20 is reciprocally moved in the direction perpendicular to the moving direction of the platen 5, while the inkjet heads 21 eject ink drops in accordance with the print data.

Next, switching of the print target data will be described. Two different ways of switching of the print target data will be described as first and second embodiments, respectively. In the first illustrative embodiment, an operation mode is set such that, when the print data is received, it overwrites the old print target data thereby the print target data is switched. In the second embodiment, the mode setting is made so that the newly received print data overwrites the previous print target data.

### FIRST EMBODIMENT

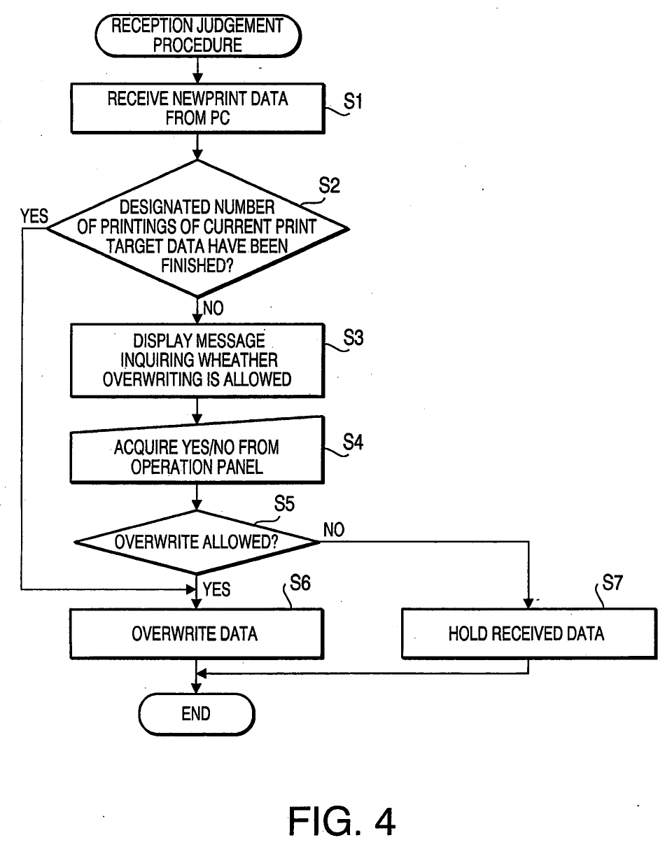

The configuration according to the first illustrative embodiment will be described with reference to FIGS. 4 through 12.

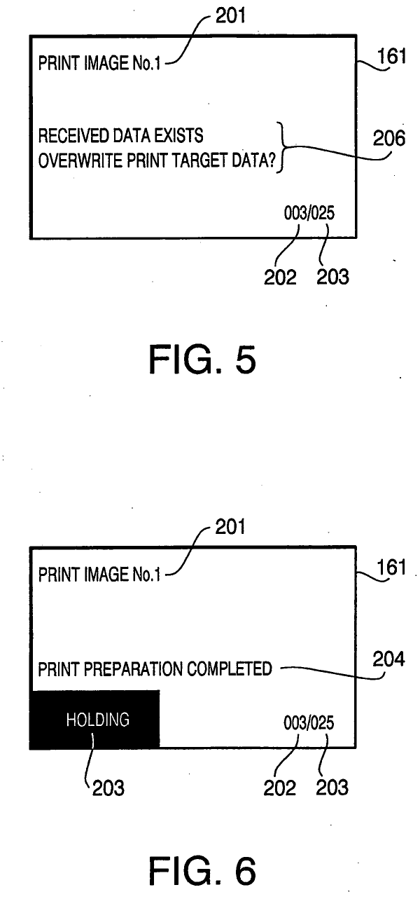

FIG. 4 is a flowchart illustrating a reception procedure according to the first illustrative embodiment. FIGS. 5 and 6 show examples of displays on the LCD 161. As shown in FIG. 4 , in the reception procedure according to the first embodiment, the process receives the new print data from a personal computer (PC) in S1. Then, the process judges whether a designated number of printings of the current print target data, which is stored in the print target data storage are 132 of the RAM 130, have been printed (S2). Specifically, when the print data is transmitted from the PC, an instruction indicating the number of printings to be printed is also transmitted. In S1, whether the designated printings have been formed is judged by checking the number of printings stored in the print number storage area 134 (S2). On the LCD 161, the print number 203 represents the number of designated printings, and the print completion number 202 represents the number of printings having been formed (see FIG. 2). If the designated number of printings have been formed, the print target data has been used and can be deleted by overwriting the new data. If the designated number of printings have not been formed, the print target data may not be deleted.

Thus, if the designated number of printings have been formed (S2: YES), the process overwrites the print target data stored in the storage area 132 with the new print data received in S1 (S6). Then, the process finishes the reception procedure.

If the designated number of printings have not been formed (S2: NO), the process displays the message 206 indicating that there is received data and inquiring whether the overwrite can be done, as shown in FIG. 5 on the LCD 161 (S3). Then, the process waits for operation of the OK button 163 or the cancel button 164 (S4). In S5, the process judges whether the OK button 163 is operated and the overwriting is allowed. If the overwriting is allowed (S5: YES), the process overwrites the print target data stored in the print target data storage area 132 with the new print data received in S1 (S6). Then, the process finishes the reception judging procedure.

If the overwriting is not allowed (S5: NO), the process stores the new print data received in S1 in the holding data storage area 133. Then, the process displays a hold-status indication 205 on the LCD 161 as shown in FIG. 6 (S7). Then, the process finishes the reception judgment procedure. It should be noted that the process may hold the received data by storing the same in the holding data storage area 133. Alternatively, the process may set a reception flag in the reception flag storage area 131 and do not receive the print data. In this case, when the overwriting is allowed, the process may transmit a resend request command and then receive the data.

In the above procedure, the process asks when the designated number of printings have not been formed. It is because the inkjet printer 1 does not start a printing job automatically upon receipt of the print data from the PC (external device, but the operation of the user is required, and thus, it is generally appropriate to leave the final judgment (i.e., whether the predetermined number of printings have been formed) to the user's decision.

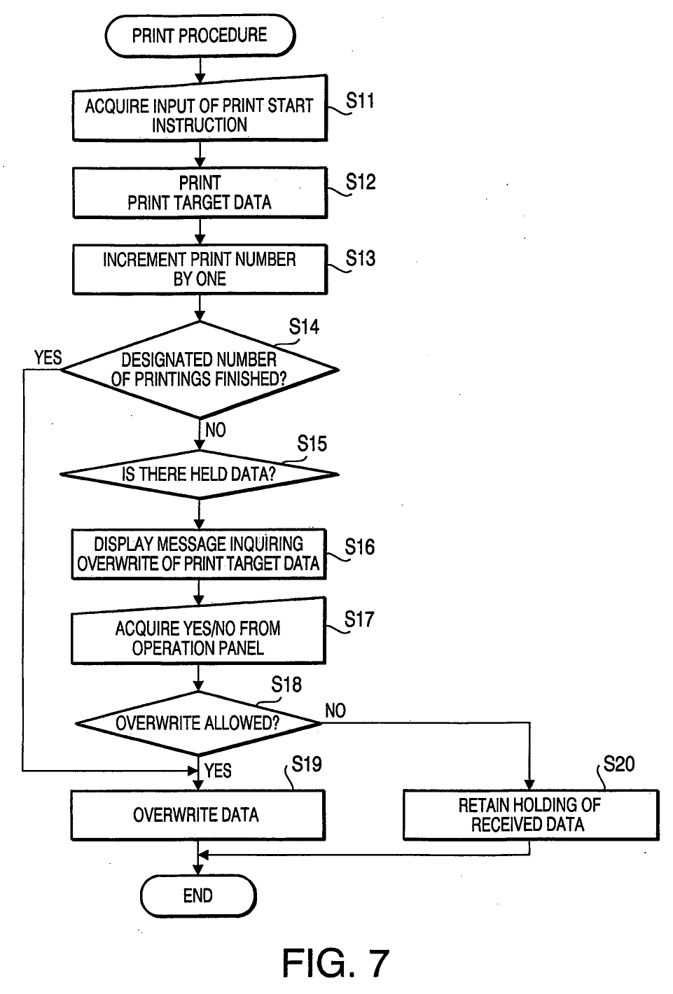

FIG. 7 is a flowchart illustrating a printing procedure according to the first embodiment. As shown in FIG. 2, when the print ready message 204 is displayed on the LCD 161, the process allows the user to depress the print start button 167 (i.e., the process is ready to accept the depression of the print start button 167) (S11). Then, after the print start button 167 is depressed, the process moves the platen and carriage as described above, and starts printing the current print target data (S12).

When the printing is finished, the process increments the print number (representing the number of printings) stored in the print number storage area 134 of the RAM 130 by one (S13). Then, the process judges whether the designated number of printings have been formed (S14). This judgment is made by comparing the print number stored in the print number storage area 134 of the RAM 130 with the designated print number when the print data was transmitted. If the designated number of printings have not been finished (S14: NO), the printing procedure is finished. Then, if the next printing operation is ready, the printing procedure is executed when the user depresses the print start button 167.

If the designated number of printings have been formed (S14: YES), the process judges whether there is data which has been received and held (S15). If there is no held data (S15: NO), it is unnecessary to switch the print data, and the process finishes the printing procedure.

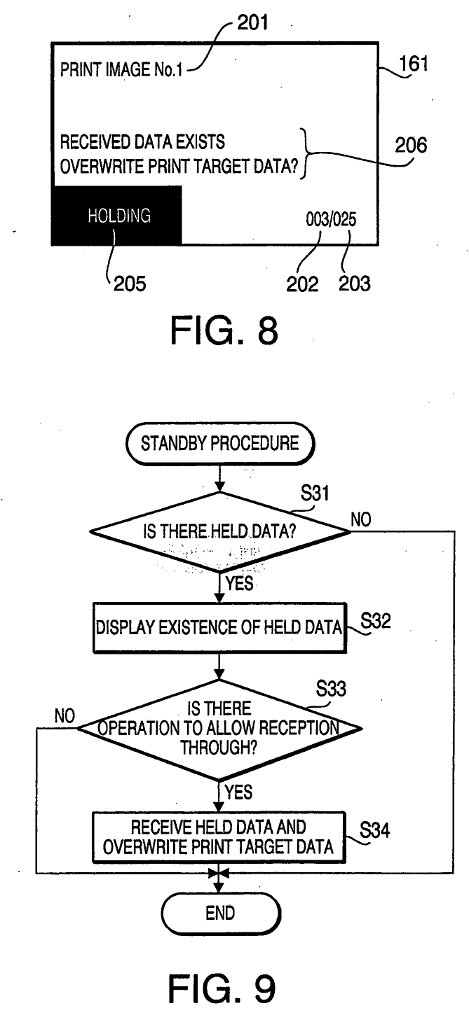

If there is held data (S15: YES), as shown in FIG. 8, a message 206 indicating that there is the held data and inquiring whether the held data overwrites the print target data (S16) with the holding indication 205 being displayed on the LCD 161. Then, the process awaits the operation of the OK button 163 or the cancel button 164 by the user (S17). Next, the process judges whether the OK button 163 is depressed and the overwriting is allowed (S18). If the overwriting is allowed (S18: YES), the process overwrites the held data stored in the held data storage area 133 on the print target data storage area 132 (S19). Then, the process finishes the printing procedure. If the overwriting is not allowed (S18: NO), the held data stored in the held data storage area 133 remains as it is, and the holding display 205 on the LCD 161 also remains (S20). Then, the process finishes the printing procedure.

FIG. 9 shows a flowchart illustrating a standby procedure according to the first embodiment. In the standby procedure, when the printing is not executed, by operating the operation panel 16, the print target data can be switched. Firstly, the process judges whether there is held data in the held data storage area 133 (S31). If there is no held data (S31: NO), since the switching of the print target data cannot be done, the process finishes the standby procedure.

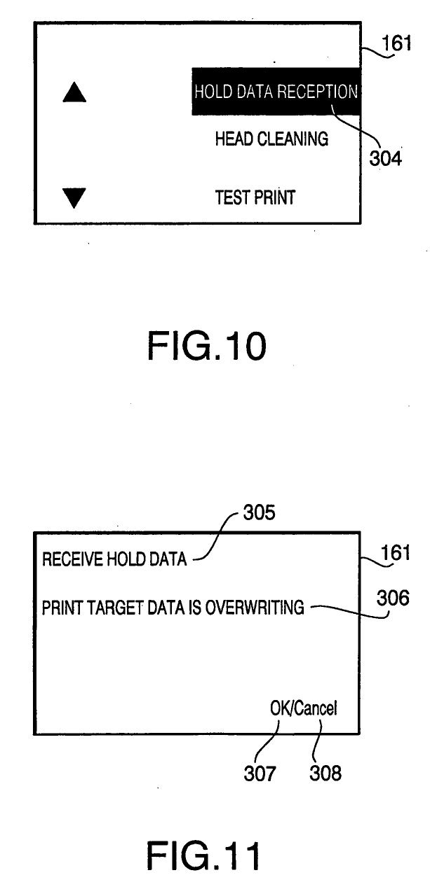

If there is the held data (S31: YES), the process displays a holding indication 205 on the LCD 161 (S32). If the menu button 162 on the operation panel 16 is depressed, the item selection image as shown in FIG. 19 is displayed. The user can move the highlighted portion on the menu items 304 by operating the move-up button 165 and move-down button 166. By depressing the OK button 163 when the desired menu item 304 is highlighted, the user can select the menu item 304. If the “held data reception” is selected on the item selection image shown in FIG. 10, the display changes to the held data reception image as shown in FIG. 11. In the held data reception image, a message 306 inquiring the overwriting on the print target data is displayed.

The process then waits for the user's operation of the OK button 163 or cancel button 164 corresponding to the OK indication 307 or the cancel indication 308 on the LCD 161. That is, the process judges whether the OK button 163 is depressed and the held data is allowed to be received (S33). If the reception of the held data is allowed (S33: YES), the process overwrites the held data stored in the held data storage area 133 on the print target data storage area 132. Alternatively, if the inkjet printer 1 is of a type which does not store the held data, the held data is received from the PC and overwrites the same on the print target data 132 (S34). Then, the process finishes the standby procedure. If the overwriting is not allowed (S33: NO), the process finishes the standby procedure.

In the first embodiment described above, when the new print data is received, it is judged whether the designated number of printings have been executed in accordance with the current print target data is finished. If finished, the new print data overwrites the previous print target data. If not, the process displays the holding indication 205 on the LCD 161, and ask the user whether the overwriting is to be done. Then, in accordance with the user's input, the process overwrites or hold the data. When the printing is executed, the process counts the number of the printed printings at every printing, compares the counted value with the designated number of printings. If the designated number of printings have been finished, the process checks whether there is held received data. If there is the held data, the process indicates that the held data exists and inquires whether overwriting is performed. Then, in accordance with user's operation through the operation panel, the process performs the overwriting or holding the data.

When the printing is not executed, the process displays an indication representing that the held data exists on the LCD 161, and depending on the user's input, the process overwrites the held data on the print target data. It should be noted that, in the first embodiment, the held data is temporarily stored in the RAM of the inkjet printer 1. However, this configuration can be modified such that, by setting the reception flag but the held data is not stored in the RAM. In this case, the held data may be received after the overwriting of the held data is allowed and the PC transmits the resend request.

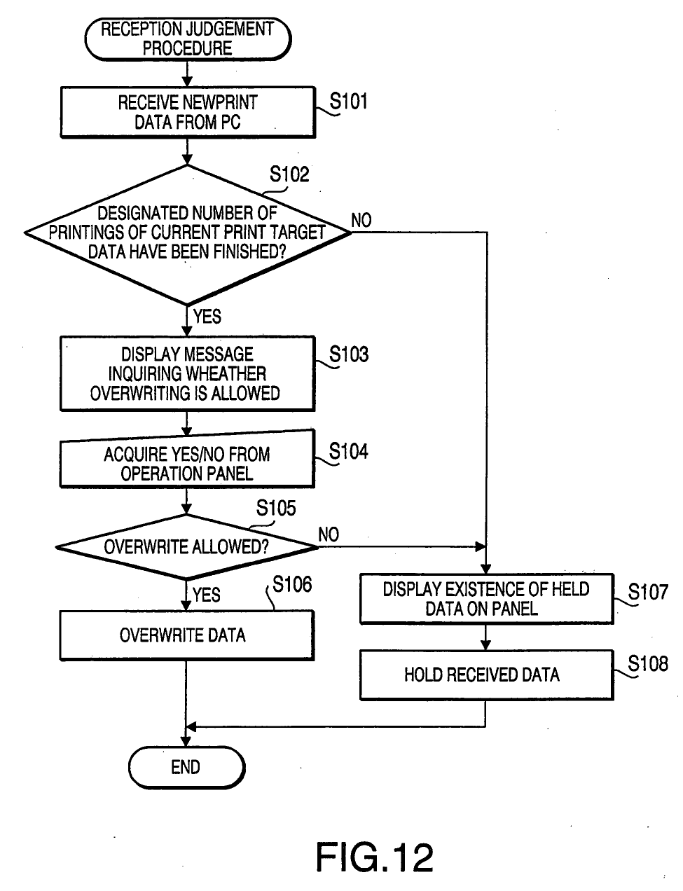

The above-described first embodiment can be modified as follows. That is, when the new print data is received, if the printing operation using the current print target data has not been finished (i.e., the designated number of printings have not been finished), only the indication of the holding data is made, while the designated number of printings have been finished, the process inquires whether the overwriting is allowed. Then, in accordance with the input by the user, the process executes the overwriting operation or holding operation. In this case, whether the held data overwrites the current print target data or not can be switched by the input through the operation panel. Such a modification will be described in detail with reference to FIG. 12.

FIG. 12 shows a flowchart illustrating the reception procedure according to a modification of the first embodiment. The process receives the new print data from the PC (S101). Then, the process judges whether the designated number of printings have been finished regarding the print target data stored in the print target data storage area 132 of the RAM 130 (S102). If the designated number of printings have been finished (S102: YES), the process displays messages 206 indicating that the received data exists, and inquiring the user whether the overwriting is allowed on the LCD 161, as shown in FIG. 5 (S103). Then, the process waits for the user's operation of the OK button 163 or the cancel button 164 (S104). In S105, the process judges whether the OK button is depressed and the overwriting is allowed. If the overwriting is allowed (S105: YES), the process overwrites the new print data received in S101 on the print target data stored in the print target data storage area 132 (S106). Then, the process finishes the reception procedure.

If the overwriting is not allowed S105: NO) or the designated number of printings have not been formed (S102: NO), as shown in FIG. 6, the holding indication 205 is displayed on the LCD 161 (S107). Then, the received new print data is stored in the held data storage area 133 or the reception flag in the reception flag storage area 131 is set to ON, thereby the received data is held (S108), and the process finishes the reception procedure.

It should be noted that the print procedure and the standby procedure are similar to those of the first embodiment. According to the configuration described above, when the new data is received, regardless whether the designated number of printings have been finished, switching to the new data will not be performed automatically, but the user's operation is required. The printing device of this type is configured such that the preparation for printing and execution thereof depend on the user. In such a printing system, the overwriting may also be left to the user's discretion. In such a case, the above-described modification may be suitable.

### SECOND EMBODIMENT

Next, the second embodiment will be described. In the second embodiment, whether the current print target data is to be switched newly received print data is executed is done by a mode setting. The second embodiment will be described with reference to FIGS. 11 through 17. In the second embodiment, the inkjet printer 1 has operation modes regarding switching of the print target data. The modes includes a “print data holding mode” in which the current print target data is retained even if the new print data is received. As a sub-mode of the print data holding mode, there is a “print number dependent mode” in which whether the data is switched is determined based on the number of printings. Each mode has “ON” and “OFF” statuses, and accordingly, the mode can be switched among “print data holding mode: OFF”, “print data holding mode: ON; print number dependent mode: ON”, and “print data holding mode: ON; print number dependent mode: OFF”.

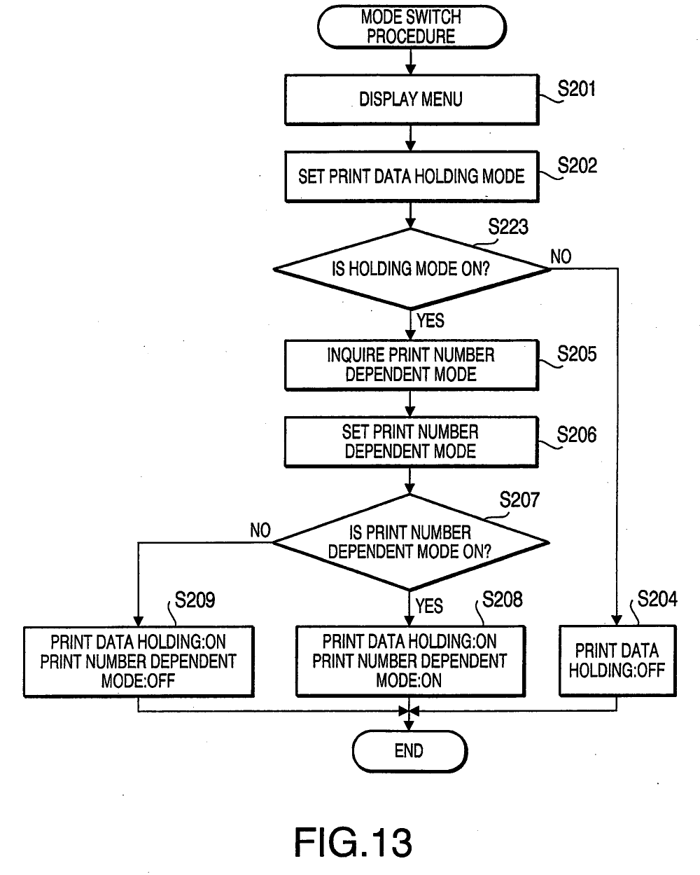

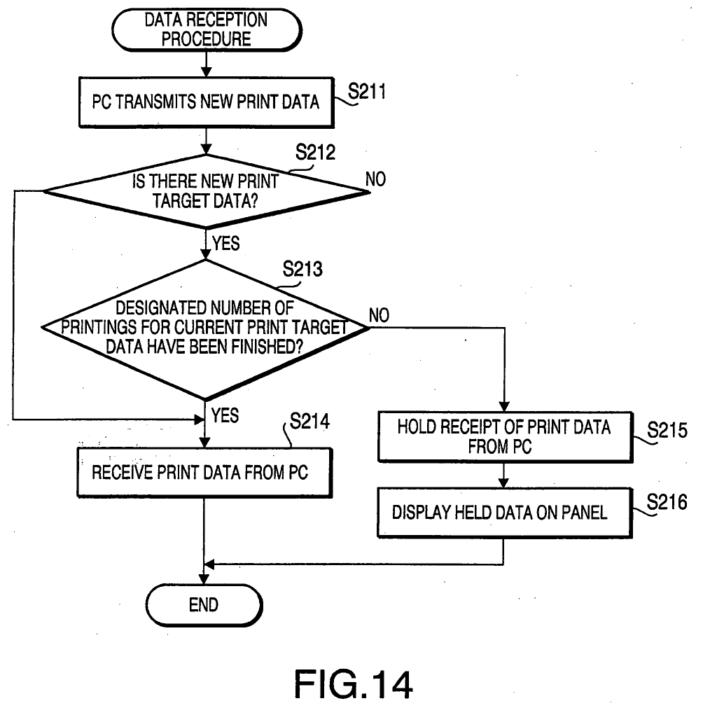

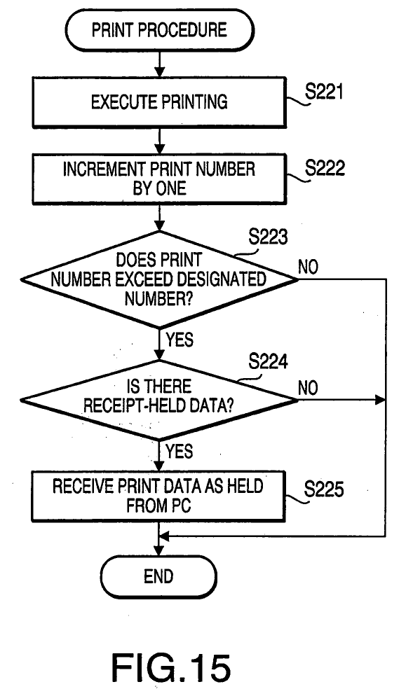

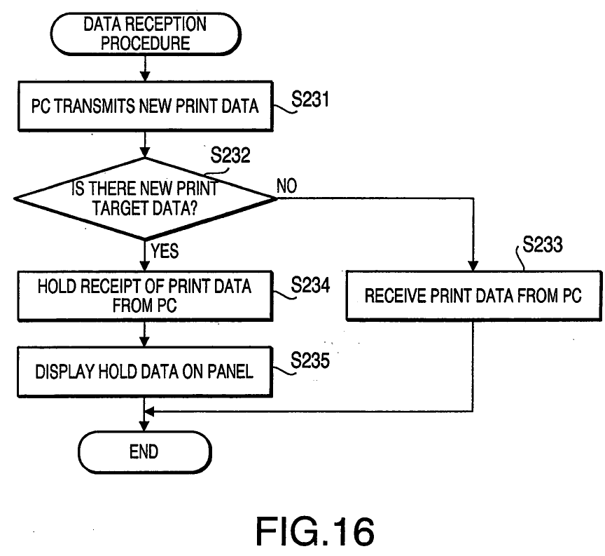

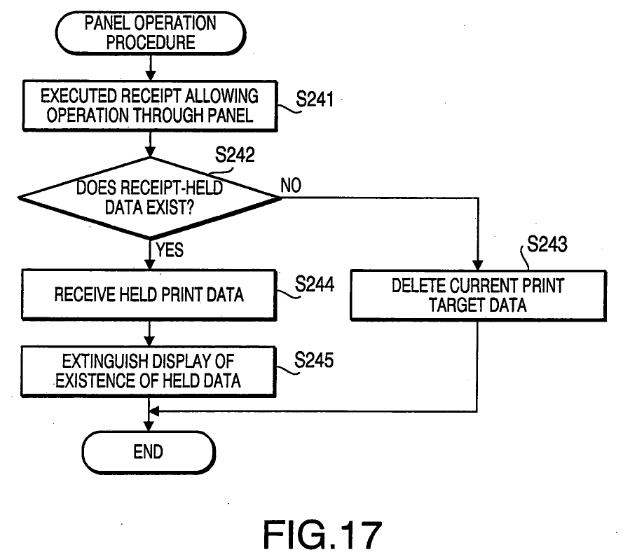

FIG. 13 shows a flowchart illustrating a mode switching procedure. FIG. 14 shows a flowchart illustrating the data reception procedure at “print data holding mode: ON; print number dependent mode: ON”. FIG. 15 shows a flowchart illustrating the printing procedure at “print data holding mode: ON; print number dependent mode: ON”. FIG. 16 shows a flowchart illustrating the data reception procedure at “print data holding mode: ON; print number dependent mode: OFF”. FIG. 17 shows a flowchart illustrating a panel operation procedure at “print data holding mode: ON; print number dependent mode: OFF”.

As shown in FIG. 13, in the mode switching procedure, the process displays a “print data holding mode setting menu” for setting the print data holding mode to ON or OFF on the LCD 161 (S201). When the user operates the move-up button 165, move-down button 166 and the OK button 163 and inputs “ON” or “OFF” through the operation panel 16, the process sets the print data holding mode to “ON” of “OFF” (S202). Then, the process judges whether the print data holding mode has been set to ON (S203). If the print data holding mode is OFF (S203: NO), the print data holding mode is set to OFF (S204). Then, the process finishes the mode switching procedure.

If the print data holding mode is ON (S203: YES), the process displays the “print number dependent mode menu” on the LCD 161, and inquires the user whether the print number dependent mode is set to “ON” or “OFF” (S205). When the user operates the move-up button 165, move-down button 166 and OK button 163 to input “ON” or “OFF” through the operation panel 16, the process sets the print number dependent mode to “ON” or “OFF” (S206). Next, the process judges whether the print number dependent mode is set to ON (S207). If the print number dependent mode is ON (S207: YES), the process sets the print number dependent mode to ON (S208). Thus, in this case, the mode is the “print data holding mode: ON; print number dependent mode: ON”. Then, the process finishes the mode switching procedure.

When the print number dependent mode is OFF (S207: NO), the process sets the print number dependent mode to OFF (S209). Therefore, in this case, the mode is “print data holding mode: ON; print number dependent mode: OFF”. Then, the process finishes the mode switching procedure.

Among the modes described above, “print data holding mode: OFF” is similar to a conventional configuration. That is, when the new print data is received from the PC, the process always overwrites the print target data with the newly received data regardless of whether the print target data exists and regardless of the value of the print number. Thus, description on this mode will be omitted, and the “print data holding mode: ON; print number dependent mode: ON” and the “print data holding mode: ON; print number dependent mode: OFF” will be described in detail below.

Referring to FIG. 14, the data reception procedure when the “print data holding mode: ON; and print number dependent mode: ON” will be described. In S211, the PC notifies of transmission of new print data. The process judges whether the print target data exists in the print target data storage area 132 of the RAM 130 (S212). If there is no print target data (S212: NO), the process received the print data from the PC, stores the received data in the print target data storage area 132 (S214), and finishes the data reception procedure.

If there is print target data (S212: YES), the process judges whether the designated number of printings have been formed regarding the print target data (S213). If the designated number of printings have been formed (S213: YES), the process receives the print data from the PC, and overwrites the print target data with the new print data in the print target data storage area 132 (S214). Then, the process finishes the data reception procedure.

If the designated number of printings have not been formed (S213: NO), the process does not received the print data and hold the receiving procedure (S215). Then, as shown in FIG. 6, the process displays a holding indication 205 on the LCD 161 (S216), and finishes the data reception procedure.

Next, referring to FIG. 15, the printing procedure when the “print data holding mode: ON; and print number dependent mode: ON” will be described. First, upon depression of the print start button 167, the process starts printing of the current print target data by moving the platen and carriage (S221). After the printing is finished, the process increments the number of printings stored in the print number storage area 134 of the RAM 130 by one (S222). Then, the process judges whether the designated number of printings have been formed (S223). If the designated number of printings have not been formed (S223: NO), the process finishes the printing procedure. If preparation for the next printing operation is completed and the user depresses the print start button 167, a new printing procedure is executed.

If the designated number of printings have been formed (S223: YES), the process judges whether the data of which reception is held exists (S224). If there is no data whose reception is held (S224: NO), it is unnecessary to switch the print target data, and the process finishes the printing procedure.

If there exists data whose reception is held (S224: YES), the process receives the print data from the PC and stores the received data in the print target data storage area 132 (S225). Then, the printing procedure is finished.

Next, referring to FIG. 16, the data receiving procedure when the “print data holding mode: ON; and the print number dependent mode: OFF” will be described. Firstly, the PC notifies that the new print data is transmitted (S231). Then, the process judges whether there exists the print target data in the print target data storage area 132 of the RAM 130 (S232). If there exists the print target data (S232: NO), the process receives the print data from the PC and stores the same in the print target data storage area 132 (S233). Then, the process finishes the data receiving procedure.

If there exist the previous print target data (S232: YES), the process holds the reception of the new data (S234). Then, as show in FIG. 6, the process displays a holding indication n205 on the LCD 161 (S235). Then, the process finishes the data receiving procedure.

Next, referring to FIG. 17, the panel operation procedure when the “print data holding mode: ON; and print number dependent mode: OFF” will be described. As shown in FIG. 17, the process acquires the data switching instruction which is made through the menu operation on the operation panel 16 (S241). Then, the process judges whether there is data whose reception is held (S242). If there is no data whose reception is held (S242: NO), the process deletes the current print target data stored in the print target data storage area 132 (S243). Then, the process finishes the panel operation procedure. By deleting the print target data, when the transmission of the new print data is notified, the process can immediately receive the new data without holding the receipt thereof.

If there is data whose reception is held (S242: YES), the process receives the print data from the PC, and stores the same in the stored target data storage area 132 (S244). Then, the process deletes the holding indication on the LCD 161 (S245). Then, the process finishes the panel operation procedure.

As described above, with the inkjet printer 1 according to the second embodiment, the data reception and the printing are executed in accordance with the mode set by the user through the operation panel 16. Therefore, the inquiry asking the user to select switching of the print target data will not be displayed on the LCD 161 every time the data is received. Thus, the inkjet printer 1 according to the second embodiment has less burden to the user. Further, in a standby state, the switching of the data to the data whose reception is held can be made at any time. Therefore, when it is necessary to switch the print target data, no problem will occur.

What is claimed is:

1. A printing device that executes a printing operation based on print data every time when a print execution instruction is issued, comprising:
a data receiving unit configured to receive print data from an external device;
a print target data storing unit configured to store print target data to be referred to when the printing operation is executed from among the data received by the data receiving unit;
a switching judgment unit configured to judge whether the print target data currently stored in the print target data storage unit should be overwritten with newly received print data;
a switching unit configured to switch the print target data stored in the print target data storing unit to the received data when the switching judgment unit determines that the print target data is to be switched; and
a holding unit configured to hold the received data until the switching judgment unit determines that the print target data should be switched.

2. The printing device according to claim 1,
further comprising:
a print number counting unit configured to count the number of printings having been formed based on the print target data stored in the print target data storage unit; and
a designated number completion judging unit configured to judge whether the number of printings counted by the print number counting unit has reached a preliminarily designated number of printings,
wherein the switching judgment unit determines that the print target data is to be switched when the designated number completion judging unit determines that the number of printings counted by the print number counting unit has reached the preliminarily designated number of printings.

3. The printing device according to claim 1,
further including:
a reception notifying unit configured to notify that the reception unit receives the print data; and
a holding notifying unit configured to notify that there exists held data which is the received data held by the holding unit.

4. The printing device according to claim 3,
further comprising:
a print number counting unit configured to count the number of printings having been formed based on the print target data stored in the print target data storage unit;
a designated number completion judging unit configured to judge whether the number of printings counted by the print number counting unit has reached a preliminarily designated number of printings; and
a switching permission input unit allowing a user to input an instruction indicating whether the print target data stored in the print target data storage unit is to be replaced with one of the received data and the held data,
wherein the reception notifying unit notifies that the print data is received when the receiving unit receives the print data and the designated number completion judging unit determines that the number of printings has reached the designated number,
wherein the holding unit holds the received data when the receiving unit receives the print data and the designated number completion judging unit determines that the number of printings has not reached the designated number,
wherein switching permission input unit inputs whether the print target data is to be switched to the received data when the reception notifying unit notifies that the print data is received,
wherein the switching judgment unit judges whether the print target data is switched based on the input through the input unit.

5. The printing device according to claim 3,
further comprising:
a print number counting unit configured to count the number of printings having been formed based on the print target data stored in the print target data storage unit;
a designated number completion judging unit configured to judge whether the number of printings counted by the print number counting unit has reached a preliminarily designated number of printings; and
a switching permission input unit allowing a user to input an instruction indicating whether the print target data stored in the print target data storage unit is to be replaced with one of the received data and the held data,
wherein the reception notifying unit notifies that the print data is received when the receiving unit receives the print data and the designated number completion judging unit determines that the number of printings has reached the designated number,
wherein the holding unit holds the received data when the receiving unit receives the print data and the designated number completion judging unit determines that the number of printings has not reached the designated number,
wherein switching permission input unit inputs whether the print target data is to be switched to the held data when the holding notifying unit notifies that there exists held data,
wherein the switching judgment unit judges whether the print target data is switched based on the input through the input unit.

6. The printing device according to claim 1,
further includes a mode setting unit that sets operation modes of the inkjet device to one of a switching mode in which the print target data is switched to the received data, and a non-switching mode in which the print target data is not switched,
wherein the switching judgment unit judges whether the print target data is switched based on the mode set by the mode setting unit.

7. The printing device according to claim 6,
further comprising a mode input unit that allows the user to input the mode,
wherein the mode setting unit executes setting of the mode based on the input through the mode input unit.

8. The printing device according to claim 6,
further comprising:
a print number counting unit configured to count the number of printings in accordance with the print target data; and
a designated number completion judging unit configured to judge whether the number of printings counted by the print number counting unit has reached a preliminarily designated number of printings,
wherein the non-switching mode includes at least one of:
an input standby mode in which the switching of the print target data is not done when the receiving unit receives the print data and the print target data is switched based on the input by the user thereafter; and
a print number dependent mode in which switching of the print target data is not done when the receiving unit receives the print data and the print target data is switched after the designated number completion judging unit judges that the designated number of printings have been formed.

9. A computer program product comprising a computer readable instructions that cause a computer to execute a printing operation based on print data every time when a print execution instruction is issued, the instructions causing the computer to execute:
a data receiving step of receiving print data from an external device;
a switching judgment step of judging whether the print target data currently stored in a print target data storage unit should be overwritten with newly received print data if it is received in the data receiving step;
a switching step of switching the print target data stored in the print target data storing unit to the received data when the switching judgment step determines that the print target data is to be switched; and
a holding step of holding the received data until the switching judgment step determines that the print target data should be switched.

10. The program product according to claim 9,
wherein the instructions further cause the computer to execute:
a print number counting step of counting the number of printings having been formed based on the print target data stored in the print target data storage unit; and
a designated number completion judging step of judging whether the number of printings counted by the print number counting unit has reached a preliminarily designated number of printings,
wherein the switching judgment step determines that the print target data is to be switched when the designated number completion judging step determines that the number of printings counted by the print number counting step has reached the preliminarily designated number of printings.

11. The program product according to claim 9,
wherein the instructions further include:
a reception notifying step of notifying that the reception unit receives the print data; and
a holding notifying step of notifying that there exists held data which is the received data held by the holding step.

12. The program product according to claim 11,
wherein the instructions further include:
a print number counting step of counting the number of printings having been formed based on the print target data stored in the print target data storage unit;
a designated number completion judging step judging whether the number of printings counted by the print number counting step has reached a preliminarily designated number of printings; and
a switching permission input step allowing a user to input an instruction indicating whether the print target data stored in the print target data storage unit is to be replaced with one of the received data and the held data,
wherein the reception notifying step notifies that the print data is received when the receiving step receives the print data and the designated number completion judging step determines that the number of printings has reached the designated number,
wherein the holding step holds the received data when the receiving unit receives the print data and the designated number completion judging step determines that the number of printings has not reached the designated number,
wherein switching permission input step inputs whether the print target data is to be switched to the received data when the reception notifying step notifies that the print data is received,
wherein the switching judgment step judges whether the print target data is switched based on the input through the input step.

13. The printing device according to claim 11,
wherein the instructions further include:
a print number counting step configured to count the number of printings having been formed based on the print target data stored in the print target data storage unit;
a designated number completion judging unit configured to judge whether the number of printings counted by the print number counting step has reached a preliminarily designated number of printings; and
a switching permission input step allowing a user to input an instruction indicating whether the print target data stored in the print target data storage unit is to be replaced with one of the received data and the held data,
wherein the reception notifying step notifies that the print data is received when the receiving step receives the print data and the designated number completion judging step determines that the number of printings has reached the designated number,
wherein the holding unit holds the received data when the receiving unit receives the print data and the designated number completion judging step determines that the number of printings has not reached the designated number,
wherein switching permission input step inputs whether the print target data is to be switched to the held data when the holding notifying step notifies that there exists held data,
wherein the switching judgment step judges whether the print target data is switched based on the input through the input step.

14. The program product according to claim 9,
further includes a mode setting step that sets operation modes of the inkjet device to one of a switching mode in which the print target data is switched to the received data, and a non-switching mode in which the print target data is not switched,
wherein the switching judgment unit judges whether the print target data is switched based on the mode set by the mode setting unit.

15. The program product according to claim 9,
further comprising a mode input unit that allows the user to input the mode,
wherein the mode setting unit executes setting of the mode based on the input through the mode input unit.

16. The program product according to claim 14,
further comprising:
a print number counting unit configured to count the number of printings in accordance with the print target data; and
a designated number completion judging unit configured to judge whether the number of printings counted by the print number counting unit has reached a preliminarily designated number of printings,
wherein the non-switching mode includes at least one of:
an input standby mode in which the switching of the print target data is not done when the receiving unit receives the print data and the print target data is switched based on the input by the user thereafter; and
a print number dependent mode in which switching of the print target data is not done when the receiving unit receives the print data and the print target data is switched after the designated number completion judging unit judges that the designated number of printings have been formed.
